(19) United States
(12) Patent Application Publication
(10) Pub. No.: US 2024/0047149 A1
(43) Pub. Date: Feb. 8, 2024

(54) ADAPTER DEVICE

(71) Applicant: Maschinenfabrik Reinhausen GmbH, Regensburg (DE)

(72) Inventors: Eduard Zerr, Regensburg (DE); Sebastian Schmid, Sinzing (DE); Roman Kagerer, Regensburg (DE); Alexander Voelkl, Schierling (DE)

(21) Appl. No.: 18/257,296

(22) PCT Filed: Nov. 18, 2021
(86) PCT No.: PCT/EP2021/082144

§ 371 Date: Jun. 14, 2023

(30) Foreign Application Priority Data
Dec. 17, 2020 (DE) 10 2020 133 891.0

(51) Int. Cl. H01H 9/00; H01C 1/01

(52) U.S. Cl. CPC H01H 9/0033; H01C 1/01

(57) ABSTRACT

An adapter device transmits tap positions of an on-load tap-changer from a control device to a secondary device. The adapter device has: an input configured to receive at least one tap position from the control device of the on-load tap-changer; an output configured to output the tap position of the on-load tap-changer to the secondary device; and at least one resistor and at least one switch, which are connected in parallel with one another. The adapter devices is configured such that: depending on the tap position of the on-load tap-changer, the at least one switch is actuated by the control device and the at least one resistor is connected or disconnected, and the output tap position of the on-load tap-changer at the output corresponds to the resistance value of the at least one resistor that has been connected or disconnected.

### CROSS REFERENCE TO RELATED APPLICATIONS

This application is a U.S. National Phase application under 35 U.S.C. § 371 of International Application No. PCT/EP2021/082144, filed on Nov. 18, 2021, and claims benefit to German Patent Application No. 10 2020 133 891.0, filed on Dec. 17, 2020. The International Application was published in German on Jun. 23, 2022 as WO 2022/128314 A1 under PCT Article 21(2).

### FIELD

The present disclosure relates to an adapter device for transmitting tap positions of an on-load tap-changer from a control device to a secondary device.

### BACKGROUND

On-load tap-changers usually have a diverter switch and a selector. The actuation of the on-load tap-changer usually takes place via a drive, which is arranged on the outside on the tank of a tap-changing transformer. The drive in this case has a motor, which is coupled to the on-load tap-changer via a gear. Inter alia, the tap position of the tap-changer, in which an indication gear with an indication is coupled to the gear, is detected via said gear. Furthermore, the indication provides an interface, which makes it possible for the tap position of the on-load tap-changer to be capable of being detected and being indicated in a control room as well. Owing to the replacement of old drives with modern drive systems, in the form of servo drives, there is no indication with an indication gear, and therefore, an interface with which it is possible to detect the tap position of the on-load tap-changer of the modern drive system using the available means or secondary technology in the control room.

### SUMMARY

In an embodiment, the present disclosure provides an adapter device that transmits tap positions of an on-load tap-changer from a control device to a secondary device. The adapter device has: an input configured to receive at least one tap position from the control device of the on-load tap-changer; an output configured to output the tap position of the on-load tap-changer to the secondary device; and at least one resistor and at least one switch which are connected in parallel with one another. The adapter devices is configured such that: depending on the tap position of the on-load tap-changer, the at least one switch is actuated by the control device and the at least one resistor is connected or disconnected, and the output tap position of the on-load tap-changer at the output corresponds to the resistance value of the at least one resistor that has been connected or disconnected.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an on-load tap-changer having an adapter device;

FIG. 2 shows a first embodiment of the adapter device; and

FIG. 3 shows a second embodiment of the adapter device.

### DETAILED DESCRIPTION

Aspects of the present disclosure provide an adapter device that has a simple and compact design, and in the process, nevertheless ensures safe operation.

The present disclosure provides an adapter device for transmitting tap positions of an on-load tap-changer from a control device to a secondary device, comprising:
an input for receiving at least one tap position from the control device of the on-load tap-changer;
an output for outputting the tap position of the on-load tap-changer;
at least one resistor having a resistance value and at least one switch which are connected in parallel with one another;
wherein:
depending on the tap position of the on-load tap-changer, the at least one switch is actuated by the control device and the at least one resistor is connected or disconnected;
the output tap position of the on-load tap-changer at the output corresponds to the resistance value of the at least one resistor which has been connected or disconnected.

The adapter device makes it possible to be able to connect modern drives of on-load tap-changers to existing secondary devices, with the result that the present tap position of the on-load tap-changer can be output via already existing indications or the like. Primarily when replacing the on-load tap-changers and the drives in existing equipment, existing secondary devices can continue to be used and do not need to be replaced. Existing secondary devices, which are in the form of, for example, indications or voltage regulators, always require, during operation, a resistance value which is output by the application of a voltage. Modern control devices of an on-load tap-changer cannot, however, have a resistor installed for each tap position to be displayed in order to thus be able to display the corresponding tap position. Furthermore, modern secondary devices exist, which then do not require a resistance value for displaying a tap position and can be connected directly to the control devices. Resistors that were then to be installed in the control device are then superfluous.

The tap positions of the on-load tap-changer are received at the input of the adapter device. The tap positions are sent or transmitted from the control device via cables. Then, the received tap positions are output at the output in the form of resistance values to a secondary device. At least one resistor and at least one switch are arranged in the interior of the adapter device. The actuation of the switch takes place on the basis of the received tap position, which is output by the control device. In this case, the switch is connected to the terminals. By virtue of the actuation of the switch, which is connected in parallel with the resistor, the resistor is connected or disconnected. By virtue of a voltage being applied at the output, the connected or disconnected resistance value can be determined, to which in turn a tap position is assigned in the secondary device. The resistor is connected to the output.

The adapter device can be designed in any desired way and can have, for example, a plurality of resistors. These can be connected in series. The resistors can in this case form a first series of resistors and a second series of resistors. Each resistor can consist of a resistor element or a plurality of resistor elements connected in series or in parallel.

The adapter device can be designed in any desired way and can have, for example, a plurality of switches. These can be connected in series. The switches can in this case form a first series of switches and a second series of switches. The switches can be in the form of relays, bistable relays or semiconductor switching elements. Particularly advantageous is the use of bistable relays as switches. These have the advantage that, in the case of an undesired power failure, the bistable relay and therefore the switch remains in the state in which it was last switched. Conventional relays would fall into a state which is intended for them for the case of a loss of voltage.

The adapter device can be designed in any desired way, with the result that, for example, the at least one switch is connected in parallel with the resistor. In one embodiment with a plurality of switches and a plurality of resistors, a switch is assigned to each resistor. Each switch is connected in parallel with a resistor. By virtue of the switches opening and closing, the individual resistors are connected in series or removed from the series circuit. The individual resistors can in this case have either always one resistance value or else different resistance values.

In one embodiment with different resistance values, it is possible, for example, for the first resistor to have 10 ohms, for the second resistor to have 20 ohms, for the third resistor to have 40 ohms, for the fourth resistor to have 80 ohms, for the fifth resistor to have 160 ohms and for the sixth resistor to have 320 ohms. These six resistors then form a first series of resistors. A second series of resistors can have an identical design. By virtue of the fact that a switch is assigned to each resistor, 64 resistance values can be set by actuation of corresponding switches, and therefore 64 tap positions of the on-load tap-changer can be output at the output. This is also possible with other resistance values as long as a resistance value doubles from the first resistance value on. A first resistance value can be 10 ohms, 40.3 ohms, 150 ohms or 400 ohms.

The input of the adapter device can be designed in any desired way and can have, for example, at least one terminal. Preferably, the at least one terminal is assigned to a switch. In accordance with a further embodiment, the input has a plurality of terminals, which are each connected to a switch and actuate said switch. The control device has a digital interface. This is connected to the input and in particular the terminals via at least one cable. The control device transmits, via the cables and the terminals, which of the switches need to be actuated in order to disconnect or connect corresponding resistors in order that, then, resistance values are generated which are assigned to tap positions in the secondary device.

The output of the adapter device can be designed in any desired way and can have, for example, a first contact, a second contact and a third contact. By applying a first voltage between the first and the second contact, a resistance value is determined which is dependent on which resistor has been connected or disconnected or which resistors have been connected or disconnected. In this case, each resistance value corresponds to a tap position of the on-load tap-changer or is assigned to a tap position of the on-load tap-changer.

The adapter device can be designed in any desired manner, wherein
the first series of resistors and the first series of switches is connected at their first end to the first contact of the output and at their second end to the second contact of the output.

The first series of resistors and the first series of switches are connected in parallel with one another. In this case, in each case one switch is connected in parallel with in each case one resistor.

The adapter device can be designed in any desired manner, wherein
a second series of switches and a second series of resistors are provided;
the second series of switches is constructed from a plurality of switches connected in series;
the second series of resistors is constructed from a plurality of resistors connected in series;
the switches are connected in parallel with in each case one of the resistors.

The adapter device can be designed in any desired manner, wherein
the first series of resistors and the first series of switches connected in parallel therewith are connected in series with the second series of resistors and the series of switches connected in parallel therewith.

The adapter device can be designed in any desired manner, wherein
the second series of resistors and the series of switches connected in parallel therewith are connected on one side to the second end of the output and on the other side to a third end of the output.

The adapter device can be designed in any desired manner, wherein
when a first voltage is applied to the first and the second terminal, a first resistance value can be determined which is dependent on the connected or disconnected resistors.

The adapter device can be designed in any desired manner, wherein
when a first voltage is applied to the first and the second contact or to the second and the third contact, a first resistance value can be determined which is dependent on the connected or disconnected resistors in the first or second series of resistors;
when a second voltage is applied to the first and the third contact, a second resistance value can be determined which is dependent on the connected or disconnected resistors in the first and the second series of resistors;
the first voltage is a reference voltage, and the second voltage is a supply voltage.

By virtue of the use of two series of resistors to which voltage can be applied at three contacts, the possibility arises of the entire regulating range, that is to say all of the tap positions which can be approached, and the present tap position in this regulating range being represented. For this purpose, however, the total resistance, i.e. the sum of the resistance values from the first and the second series of resistors, always needs to remain the same. For this purpose, corresponding resistors in the first series of resistors are connected and corresponding resistors in the second series of resistors are disconnected via the control device.

The adapter device can be designed in any desired way and can have, for example, a first series of resistors and a second series of resistors. Each series of resistors has precisely six resistors. The first resistor in the first series of resistors has a specific resistance value. The second resistance value of the second resistor is double that of the first resistor. The third resistor has double the resistance value of the second resistor, the fourth resistor has double the resistance value of the third resistor, the fifth resistor has double the resistance value of the fourth resistor and the sixth resistor has double the resistance value of the fifth resistor. The first series of resistors and the second series of resistors are of identical design. Furthermore, the adapter device has a first series of switches and a second series of switches. The series of switches are of identical design. Each series of switches has precisely six switches, of which each is a bistable relay.

Furthermore, an arrangement is provided which comprises the adapter device, the on-load tap-changer and the control device. The control device and the motor form the drive. The arrangement makes it possible for on-load tap-changers with modern drives to be capable of being connected to existing secondary devices, with the result that the present tap position of the on-load tap-changer can be output via already existing indications or the like. Primarily when replacing the on-load tap-changers and the drives in existing equipment, existing secondary devices can continue to be used and do not need to be replaced. Existing secondary devices which are in the form of, for example, indications or voltage regulators always require, during operation, a resistance value which is output by the application of a voltage. Modern control devices of an on-load tap-changer cannot, however, have a resistor installed for each tap position to be displayed in order to thus be able to display the corresponding tap position. Furthermore, modern secondary devices exist, which then do not require a resistance value for displaying a tap position and can be connected directly to the control devices. Resistors which were then to be installed in the control device are then superfluous.

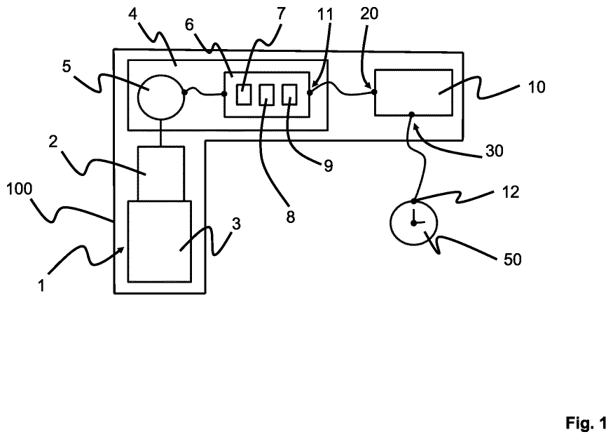

FIG. 1 shows an on-load tap-changer 1 having a diverter switch 2 and a selector 3. The on-load tap-changer 1 is actuated by means of a motor 5. The motor 5 is connected to a control device 6. The control device 6 comprises a power section 7, a converter 8 and a control unit 9. The control device 6 detects, inter alia, the tap position of the on-load tap-changer 1. The tap position of the on-load tap-changer 1 describes which winding tap of a tap winding in a tap-changing transformer is being contacted at that time. The motor 5 and the control device 6 form the drive 4. The control device 6 has a first interface 11, via which the tap position of the on-load tap-changer 1 is output. The first interface 11 is in the form of, for example, a plug with terminals. The first interface 11 is a digital interface which outputs a digital signal which transmits the tap position of the on-load tap-changer 1.

The first interface 11 is connected to an input 20 of the adapter device 10 via cables. The adapter device 10 has an output 30, which in turn is connected to a second interface 12 of a secondary device 50 via cables. The secondary device 50 can be in the form of an indication, in the form of a voltage regulator, an evaluation unit or the like.

Furthermore, an arrangement 100 is depicted. This arrangement comprises the adapter device 10 and/or the control device 6 and/or the motor 5 and/or the drive 4 and/or the on-load tap-changer 1. Preferably, the arrangement 100 comprises the adapter device 10, the control device 6 of the drive 4 and the on-load tap-changer 1. The arrangement 100 is connected to the secondary device 50 by means of adapter device 10.

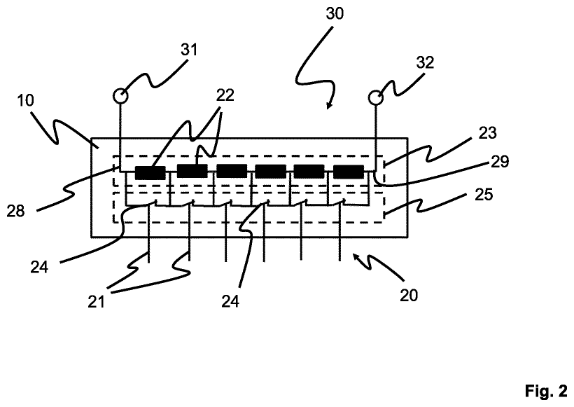

FIG. 2 shows a first embodiment of the adapter device 10 according to an aspect of the present disclosure. The input 20 of the adapter device consists of a multiplicity of terminals 21. The tap positions of the on-load tap-changer 1 which are output by the control device 6 are received at the input 20 and in particular across the terminals 21. Furthermore, a plurality of series-connected resistors 22 is arranged in the interior of the adapter device 10. These resistors form a first series of resistors 23. In each case one switch 24 is arranged or connected in parallel with each resistor 22. Each resistor 22 can consist of or be constructed from a single resistor or a plurality of resistors connected in series or in parallel.

The plurality of switches 24 is also connected in series and forms a first series of switches 25. By opening and closing of the corresponding switches 24, the corresponding resistors 22 are removed from the series circuit or connected thereto. As is illustrated in FIG. 2, it is therefore possible with the aid of the switches 24 to connect all of the resistors 22 in series, to connect only some of the resistors 22 in series or else to connect none of the resistors 22 in series.

The actuation or the driving of the switches 24 takes place via the respective terminals 21 of the input 20 by the control device 6. Depending on the tap position of the on-load tap-changer 1, corresponding switches 24 are actuated by the control device 6 and therefore corresponding resistors 22 are connected in series.

If the control device 6 notifies in respect of a tap position of the on-load tap-changer 1, the corresponding switch 24 or the corresponding switches 24 is or are opened or closed via the corresponding terminal 21 or corresponding terminals 21. The adapter device 10 therefore converts digital signals at the outputs of a control device 6 into corresponding resistance values in the adapter device 10.

The first series of resistors 23 and the first series of switches 25 are connected at their ends to a first end 28 and a second end 29, which is arranged opposite the first end 28.

The first end 28 and the second end 29, which is arranged opposite the first end 28, of the series of resistors 23 and the series of switches 25 are connected to the output 30 of the adapter device 10. In particular, the first end 28 is connected to a first contact 31 and the second end 29 is connected to a second contact 32.

By virtue of the application of a first voltage at the first and the second contact 31,32, a current is set which changes on the basis of the connected or disconnected resistors 22. By means of a secondary device 50, which can be connected to the output 30 of the adapter device the first resistance value is processed or represented. The secondary device 50 can be in the form of an indication, a voltage regulator or the like. In the case of a configuration of the secondary device 50 in the form of an indication, the corresponding tap positions of the on-load tap-changer 1 are assigned to the resistance values and then indicated, for example, by a pointer.

In one possible embodiment, the resistors 22 have an equal resistance value. Thus, a series of resistors of at most six resistance values can be interconnected. For example, six times ohms. In conjunction with six switches 24, it is also possible for only six tap positions of an on-load tap-changer 1 to be indicated at the secondary device 50, processed there or output thereto.

Alternatively, the resistors 22 having different resistance values can be connected in series. In such an embodiment, the resistance value doubles from left to right, in particular from 10 ohms, 20 ohms, 40 ohms, 80 ohms, 160 ohms, 320 ohms. By connecting the resistors 22 in series in a targeted manner, it is thus possible for 64 resistance values to be produced at the output 30, which then correspond to 64 tap positions of an on-load tap-changer 1.

Alternatively, any desired resistance value can be used as first value and then needs to be doubled.

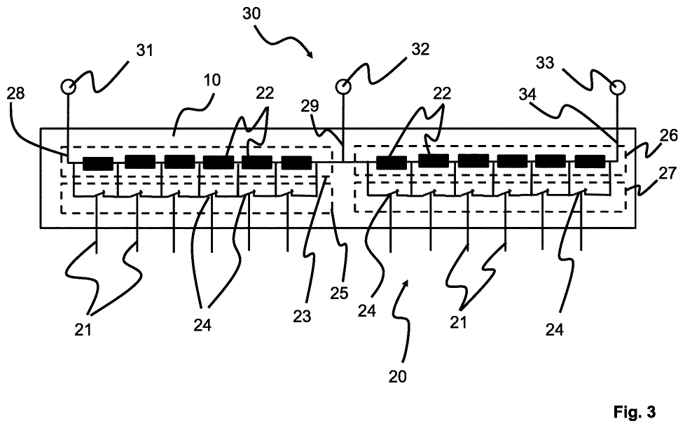

FIG. 3 shows a further embodiment of the adapter device 10, however with a reference function. Here, a second series of resistors 26 is connected in series with the first series of resistors 23. A second series of switches 27 is connected in series with the first series of switches 25. The series of resistors 23, 26 and the series of switches 25, 27 are in this case of identical design. The series-connected resistors 22 in the first series of resistors 23 have the same resistance values as the series-connected resistors 22 in the second series of resistors 26. The number of switches 24 in the first series of switches 25 corresponds to the number of switches 24 in the second series of switches 27.

A third contact 33 is arranged at the third end 34 of the second series of resistors 26 and is likewise part of the output 30. The third end 34 is arranged opposite the first end 28. The second contact 32 is connected between the first and the second series of resistors 23, 26 and the first and the second series of switches 25, 27. During operation, a constant second voltage (supply voltage) is applied to the first and third contacts 31, 33, with the result that a current is set which is dependent on the resistors 22 in the series of resistors 23, 26 which are connected or disconnected by the switches 24. Then, the respective first voltage (reference voltage) can be applied at the first and second contact 31, 32, alternatively at the second and third contact 32, 33, and then a current (reference current) can be measured. The sum of the two voltages, i.e. the voltages between the first and second contacts 31, 32 and the second and third contacts 32, 33, must always be equal to the second voltage (supply voltage) between the first and the third contact 31, 33. For this purpose, however, the total resistance or the second resistance value remains the same between the first and the third contact 31, 33. For this purpose, when a tap position of the on-load tap-changer 1 is output, a switch 24 in the first series of switches 25 and a switch in the second series of switches 27 is actuated. As a result, a resistor 22 in the first series of resistors 23 is connected and a corresponding resistor 22 in the second series of resistors 26 is disconnected. Thus, both the first voltage (reference voltage) between the first and the second contact 31, 32 and also the first voltage (reference voltage) between the second and third contact 32, 33 changes. The second voltage (supply voltage) between the first contact 31 and the third contact 33 remains the same. As mentioned, the sum of the two series of resistors always remain the same. For the case where no resistor 22 is connected in the first series of resistors 23, all of the resistors 22 are connected in the second series of resistors 23. The actuation of the corresponding switches 24 takes place via the control device 6.

The embodiment with three contacts 31, 32, 33 is primarily intended for secondary devices 50 which use the total resistance, i.e. the second resistance value, for depicting the entire regulating range, that is to say all of the tap positions of an on-load tap-changer 1, from the first to the last tap position. This applies, for example, to secondary devices 50 which are in the form of indications. Here, the second voltage (supply voltage) or the second resistance value or total resistance is used as the basis for the representation of an entire regulating range. In other words, all of the tap positions of an on-load tap-changer 1 are represented. The first voltage (reference voltage) is then used for representing the present tap position in the entire regulating range of the on-load tap-changer 1.

The switches 24 can be in the form of relays, bistable relays or semiconductor switching elements.

The resistors 22 can be in the form of a multiple of 10 ohms, 40.3 ohms, 150 ohms and 400 ohms, etc. Furthermore, the resistors can be constructed for a resistance value from a plurality of elements connected in series or in parallel.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 on-load tap-changer
2 diverter switch
3 selector
4 drive
5 motor
6 control device
7 power section
8 converter
9 control unit
10 adapter device
11 first interface
12 second interface
20 input
21 terminal
22 resistor
23 first series of resistors
24 switch
25 first series of switches
26 second series of resistors
27 second series of switches
28 first end
29 second end
30 output
31 first contact
32 second contact
33 third contact
34 third end
50 secondary device
100 arrangement

1. An adapter device for transmitting tap positions of an on-load tap-changer from a control device to a secondary device, the adapter device comprising:
an input configured to receive at least one tap position from the control device of the on-load tap-changer;
an output configured to output the tap position of the on-load tap-changer to the secondary device; and
at least one resistor and at least one switch which are connected in parallel with one another,
wherein the adapter devices is configured such that:
depending on the tap position of the on-load tap-changer, the at least one switch is actuated by the control device and the at least one resistor is connected or disconnected, and
the output tap position of the on-load tap-changer at the output corresponds to the resistance value of the at least one resistor that has been connected or disconnected.

2. The adapter device as claimed in claim 1, wherein:
a plurality of resistors is provided, the plurality of resistors comprising the at least one resistor;
the resistors are connected in series, and
the series-connected resistors form a first series of resistors.

3. The adapter device as claimed in claim 1, wherein:
a plurality of switches is provided,
the switches are connected in series, and
the series-connected switches form a first series of switches.

4. The adapter device as claimed in claim 2, wherein:
in each case, one switch is connected in parallel with a respective one of the resistors.

5. The adapter device as claimed in claim 1, wherein:
the input has at least one terminal,
each terminal is coupled to at least one switch or is assigned to one switch, and
the control device is configured to actuate the corresponding switch via the respective terminal.

6. The adapter device as claimed in claim 1, wherein:
the output has a first contact and a second contact,
the adapter device is configured such that, by applying a first voltage between the first contact and the second contact, a resistance value is determined which is dependent on which resistor has been connected or disconnected or which resistors have been connected or disconnected,
the at least one tap position is one of a plurality of tap positions, and
each resistance value corresponds to or is assigned to a respective one of the tap positions of the on-load tap-changer.

7. The adapter device as claimed in claim 1, wherein:
a first series of resistors and a first series of switches are connected at their first end to a first contact and at their second end to a second contact.

8. The adapter device as claimed in claim 7, wherein:
the adapter device further comprises a second series of switches and a second series of resistors,
the second series of switches is constructed from a plurality of switches connected in series,
the second series of resistors is constructed from a plurality of resistors connected in series, and
the switches of the second series of switches are connected in parallel with in each case one of the resistors of the second series of resistors.

9. The adapter device as claimed in claim 8, wherein:
the first series of resistors and the first series of switches connected in parallel therewith are connected in series with the second series of resistors and the series of switches connected in parallel therewith.

10. The adapter device as claimed in claim 7, wherein:
a second series of resistors and a second series of switches connected in parallel therewith are connected on one side to the second end and on the other side to a third end.

11. The adapter device as claimed in claim 10, wherein:
the output has a third contact which is connected to the third end.

12. The adapter device as claimed in claim 1, wherein:
the adapter device is configured such that, when a first voltage is applied to the first terminal and the second terminal, a first resistance value is determined which is dependent on the connected or disconnected resistors.

13. The adapter device as claimed in claim 11, wherein:
the adapter device is configured such that, when a first voltage is applied to the first contact and the second contact or to the second contact and the third contact, a first resistance value is determined that is dependent on the connected or disconnected resistors in the first series of resistors or the second series of resistors,
the adapter device is configured such that, when a second voltage is applied to the first contact and the third contact, a second resistance value is determined that is dependent on the connected or disconnected resistors in the first series of resistors and the second series of resistors, and
the first voltage is a reference voltage, and the second voltage is a supply voltage.

14. An arrangement, the arrangement comprising:
the adapter device as claimed in claim 1;
an on-load tap-changer; and
a control device.

15. The arrangement as claimed in claim 14, further comprising
a drive having a motor and the control device.
